(19) United States
(12) Patent Application Publication
(10) Pub. No.: US 2017/0015521 A1
(43) Pub. Date: Jan. 19, 2017

(54) METHOD AND DEVICE FOR MONITORING THE MOVEMENT OF AT LEAST ONE DOOR, IN PARTICULAR AN ELEVATOR DOOR

(71) Applicants: Mustapha TOUTAOUI, Berlin (DE); OTIS ELEVATOR COMPANY, Farmington, CT (US)

(72) Inventor: Mustapha TOUTAOUI, Berlin (DE)

(21) Appl. No.: 15/124,836

(22) PCT Filed: Mar. 19, 2014
(86) PCT No.: PCT/EP2014/055536

§ 371 Date: Sep. 9, 2016

(51) Int. Cl. B66B 5/00; B66B 5/02; B66B 3/00; B66B 1/28; B66B 9/00; B66B 13/02

(52) U.S. Cl. CPC B66B 5/0018; B66B 9/00; B66B 13/02; B66B 3/002; B66B 5/0031; B66B 1/28; B66B 5/0025; B66B 5/02

(57) ABSTRACT

A device for monitoring a movement of at least one door (6, 16), in particular an elevator door (6, 16) comprises: at least one picture recording device (18) configured for recording a plurality of pictures of at least one portion of the at least one door (6, 16) during a movement of the at least one door (6, 16); at least one storing device (17) configured for storing a plurality of reference pictures; a comparison device (19), which is configured for comparing at least one of the recorded pictures with at least one of the reference pictures to determine a difference measure representative of the difference between the at least one stored picture and the at least one reference picture; and for issuing an alarm message when the difference measure exceeds a predetermined limit.

The present invention relates to a method and a monitoring device for monitoring the movement of at least one door, in particular an elevator door. The invention further relates to an elevator system comprising a device for monitoring the movement of its doors.

Elevator systems respectively comprise at least on hoistway and at least one elevator car moving along the length of said hoistway. Moving doors are provided at the hoistway as well as at the car allowing passengers to transfer between landing zones formed at different floors next to the hoistway and the elevator car when the elevator car is positioned next to a landing zone. For a safe operation of the elevator system, the doors need to be reliably shut before the elevator car starts to move in order to prevent passengers from falling into the hoistway.

As the doors comprise mechanical moving elements which are subjected to wear and/or damage by careless passengers, they are a critical component which frequently causes a malfunction, shut down or blockage of the elevator system.

Thus, it would be beneficial to be able to continuously monitor the movement of the elevator doors not only to detect a failure/blockage of the doors, but to also detect minor disturbances of the door movement in advance of a blockage in order to allow repairing the door even before a blockage occurs and the elevator system is shut down completely.

According to an exemplary embodiment of the invention, a vision sensor (picture recording device) is provided in a position allowing to supervise the functionality of the doors checking movement of the doors and/or door locks in order to issue a message, e.g. a warning/alarm signal, in case the actual movement of the doors deviates considerably from a predetermined (ideal) movement of the doors.

According to an exemplary embodiment of the invention, a monitoring device for monitoring a movement of at least one door, in particular an elevator door, comprises: (a) at least one picture recording device or vision sensor configured for recording a plurality of pictures of at least one portion of the at least one door during a movement of the at least one door; (b) a storing device configured for storing a plurality of reference pictures; and (c) a comparison device. The comparison device is configured for comparing at least one of the recorded pictures with at least one of the reference pictures stored within the storage device for determining a difference measure which is representative of the difference between the at least one stored picture and the at least one reference picture; and for issuing a message in case the difference measure exceeds a predetermined limit.

Exemplary embodiments of the invention further include an elevator system comprising a hoistway extending in a basically vertical direction; at least one elevator car configured for moving along the length of the hoistway; at least one moveable door; and a monitoring device according to an exemplary embodiment of the invention for monitoring a movement of said at least one door. The monitoring device may be configured for monitoring the movement of the door of an elevator car. Alternatively or additionally, the elevator system comprises at least one hoistway door and the monitoring device is configured for monitoring the movement of said hoistway door.

A method of monitoring a movement of at least one door, in particular an elevator door, according to an exemplary embodiment of the invention comprises the steps of:
(A) recording a plurality of pictures of at least one portion of the at least one door during the movement of said elevator door;
(B) comparing the recorded pictures with stored reference pictures in order to determine a difference measure representative of the difference between the stored pictures and the reference pictures;
(C) comparing the difference measure with a predetermined limit; and
(D) issuing a message if the difference measure exceeds the predetermined limit. The message may be an alarm message or a warning message.

Exemplary embodiments of the invention, which will be described in more detail below with reference to the encloses figures allow to continuously monitor the positions of moving parts of the elevator doors allowing error detection and predictive maintenance reducing the shut-down times of the elevator system as it allows a rapid reaction repairing and/or replacing the affected parts before a blockage occurs. Due to continuously monitoring the status of the elevator, disturbances are detected at an early stage and the performance and position accuracy of the elevator is preserved.

As a result the availability of the elevator system for passengers is increased and service costs are reduced, enhancing customer satisfaction.

The proposed method is applicable for all kinds of elevators, in particular elevators having central opening doors and telescopic doors.

The disclosure of the invention will become more easily understood with reference to the accompanying drawings.

The figures and the following discussion describe particular embodiments of the invention so as to teach those skilled in the art how to produce and use the best modes of the invention. In order to teach the principle of the invention, several conventional aspects have been simplified or omitted. Those skilled in the art should understand that variations originating from these embodiments also fall within the scope of the invention. Those skilled in the art should understand that the features to be described below can be combined in various ways so as to form numerous variations of the invention. Therefore, the invention is not limited to the following particular embodiments and is merely defined by the appended claims and their equivalents.

### SHORT DESCRIPTION OF THE DRAWINGS

FIG. 1 shows a schematic illustration of an elevator system according to an exemplary embodiment of the invention.

FIGS. 2a and 2b respectively show an elevator car according to exemplary embodiments of the invention.

FIG. 3 schematically shows an elevator car within a hoistway from above.

FIGS. 4a and 4b schematically show a central opening door in its fully open state and in its completely closed state.

FIGS. 5a to 5d schematically illustrate the movement of opening an elevator car door.

FIG. 6 schematically illustrates the method of analysing the recorded pictures.

### DETAILED DESCRIPTION OF THE DRAWINGS

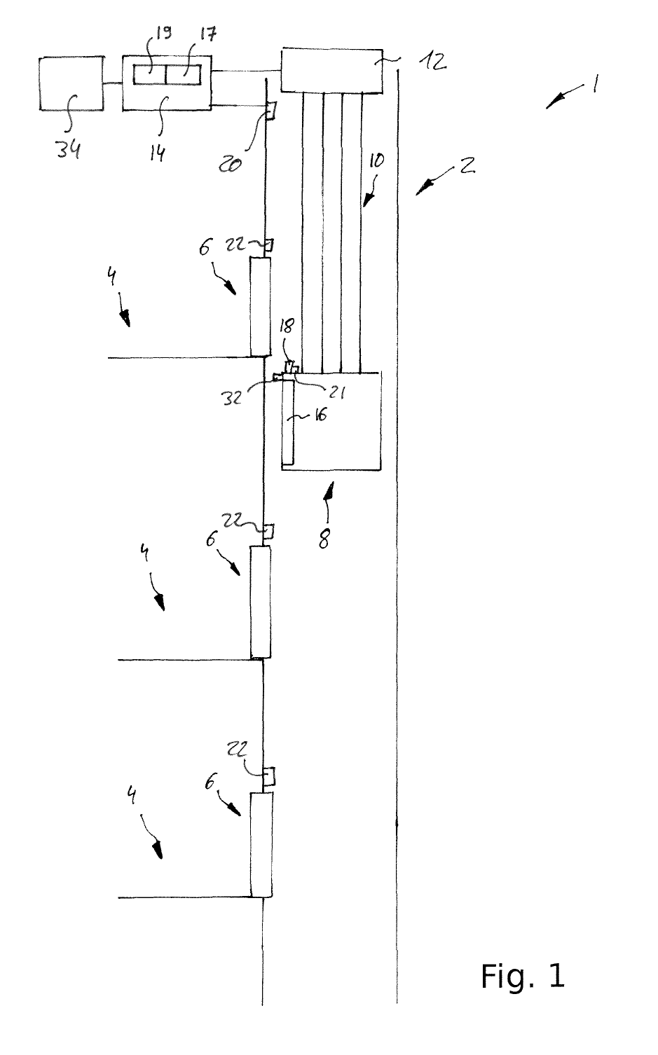

FIG. 1 shows a schematic illustration of an elevator system 1 according to an exemplary embodiment of the invention, the elevator system 1 comprising a hoistway 2 extending between a plurality of floors 4. At least one hoistway door 6 is provided at each floor 4 allowing access to the hoistway 2 from the floor 4.

An elevator car 8 is suspended by means of a plurality of tension members 10 within the hoistway 2, the tension members 10 being connected to an elevator drive 12 provided at the top of the hoistway 2 allowing to move the elevator car 8 along the longitudinal extension of the hoistway 2 between the plurality of floors 4 by operating the elevator drive 12. The elevator drive 12 may be located in any other portion of the hoistway, e.g. in the pit, or may even be located in a separate machine room.

The elevator car 8 comprises at least one elevator car door 16, which is located opposite to a corresponding hoistway door 6 when the elevator car 8 is positioned at a specific floor 4. The car door 16 and the corresponding hoistway door 6 open in coordination to each other in order to allow passengers to transfer between the elevator car 8 and the respective floor 4.

The elevator drive 12 is functionally connected to an elevator control 14 controlling the movement of the elevator car 8 and the opening and closing of the doors 6, 16.

A plurality of elevator control means, which are not shown in FIG. 1, are provided at each of the floors 4 and/or within the elevator car 8 allowing passengers to input control commands causing the elevator drive 12 to move the elevator car 8 to a desired floor 4.

In order to ensure a safe operation of the elevator system 1 it is desirable to control the movement of the doors 6, 16, in particular to ensure that all doors 6, 16 are perfectly closed before the elevator car 8 is moved, in order to prevent passengers from falling into the hoistway and/or getting trapped between the floor 4 and the moving elevator car 8.

Thus, according to an exemplary embodiment of the invention, a picture recording device 18 is provided at the elevator car 8 in a position allowing to record pictures of the car door 16 and/or a hoistway door 6, which is located opposite to the car door 16 when the elevator car 8 is positioned at a specific floor 4.

The picture recording device 18 is configured for transferring the data of the recorded pictures to the elevator control 14, which is configured for evaluating the transferred data in order to monitor the movement of the doors 6, 16 and in particular to detect an incomplete number of pictures or deviations between the recorded pictures and store reference pictures during the opening and/or closing of the doors 6, 16.

The data may be transferred via wires (e.g. wires of a travelling cable), which are not shown in FIG. 1, extending basically parallel to the tension members 10 along the hoistway 2, or wireless by means of a transmitter 21 connected or integrated with the picture recording device 18 and at least one corresponding receiver 20 located within or near to the hoistway 2.

As an optional feature, labels 22, which e.g. may include a bar code identifying the respective floor 4, may be arranged next to each floor 4 allowing the elevator control 14 to determine the vertical position of the elevator car 8 within the hoistway 2 by identifying the respective label 22 within the picture(s) recorded by the picture recording device 18.

The picture recording device 18 may further comprise an illuminating device 32 which is configured for illuminating at least the portions of the doors 6, 16 and 7 or labels 22 to be inspected.

In the following the invention will be described in more detail with respect to a central opening door 16. The skilled person, however, will easily understand that the invention may be similarly applied to telescopic doors, as well.

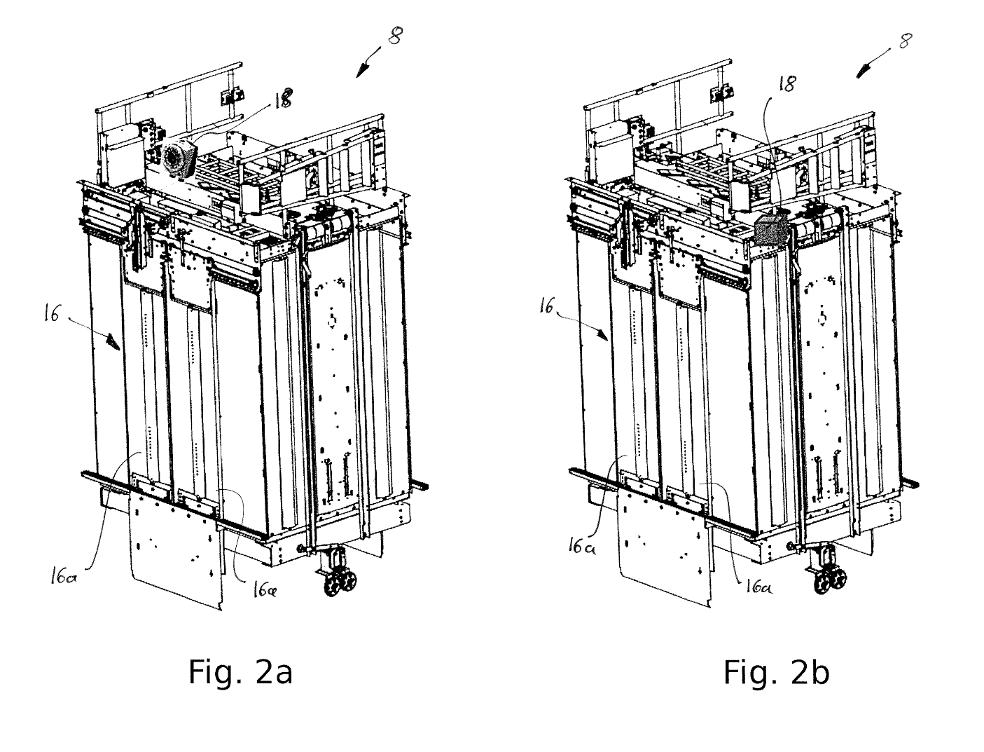

FIGS. 2a and 2b respectively show an elevator car 8 according to exemplary embodiments of the invention.

At its front side each of the cars 8 is provided with a central opening door 16 comprising two door panels 16a.

In the embodiment shown in FIG. 2a, the picture recording device 18 is positioned in a central position on top of the elevator car 8 allowing viewing and inspecting the movement of the door panels 16a of the central opening door 16 from above.

In the embodiment shown in FIG. 2b, the picture recording device 18 is located at the right side of the elevator car 8 above the height of the central opening door 16 in order to laterally view and inspect the movement of the door panels 16a.

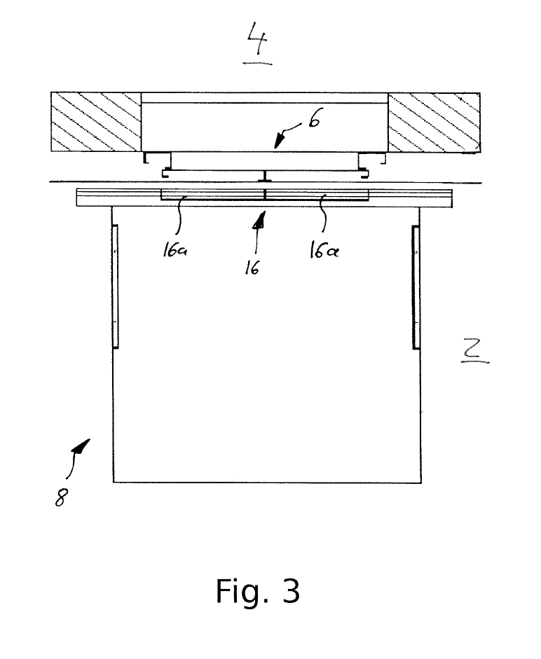

FIG. 3 schematically shows an elevator car 8 with its elevator car door 16 comprising two door panels 16a and a corresponding hoistway door 6 within the hoistway 2 from above.

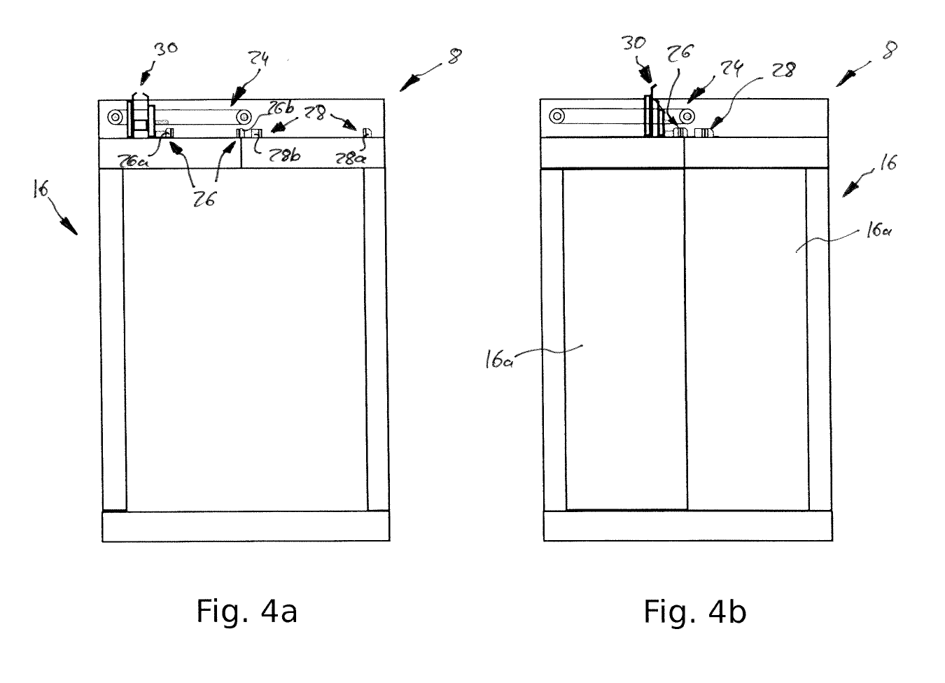

FIGS. 4a and 4b schematically show a central opening door 16 in its fully open state (FIG. 4a) and in its completely closed state (4b), respectively.

A door drive mechanism 24 and door vanes 30 are schematically illustrated on top of the door 16. Also shown are the car door lock 26 and the hoistway door lock 28.

The shoes 26a, 26b, 28a, 28b of the door locks 26, 28 are positioned in contact with each other, when the corresponding door 6, 16 is completely closed (FIG. 4b). The shoes 26a, 26b, 28a, 28b are spaced apart from each other, when the corresponding door 6, 16 is in its open state (FIG. 4a).

Thus, the movement of the doors 6, 16 can be reliably monitored by inspecting the positions and in particular the movement of the door locks 26, 28. Further information may be achieved by additionally monitoring the movement of the door vanes 30.

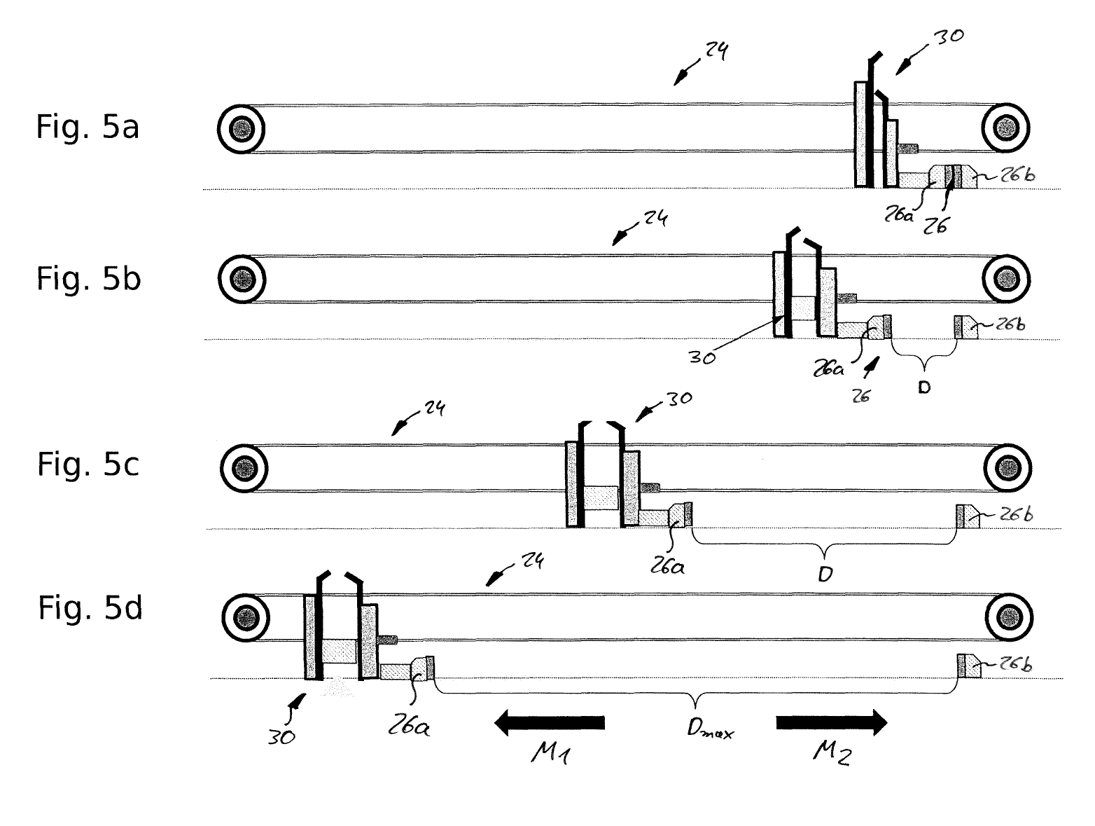

FIGS. 5a to 5d schematically illustrate the movement Ml of opening an elevator car door 16 in more detail.

In FIG. 5a the car door 16 is completely closed, the door vanes 30 are arranged next to the right end of the door drive mechanism 24 and the shoes 26a, 26b of the car door lock 26 are positioned in contact with each other.

In the following FIGS. 5b, 5c the car door 16 gradually opens, the door vanes 30 and the moveable shoe 26a of the car door lock 26 moving to the left creating a distance D between the moveable car door lock shoe 26a and the fixed car door lock shoe 26b. Said distance D reaches its maximum Dmax in the situation shown in FIG. 5d, when the car door 16 is positioned in its completely open state.

In the corresponding closing motion (M2) the door vanes 30 and the moveable shoe 26a of the car door lock 26 move to the right again reducing the distance D between the moveable car door lock shoe 26a and the fixed car door lock shoe 26b until the contact each other when the car door 16 reaches its completely closed state, as shown in FIG. 5a.

In an exemplary embodiment of the invention, a plurality of pictures, which are similar to the pictures shown in FIGS. 5a-5d, are recorded in the course of a correct (ideal) opening and closing movements M1, M2 of the elevator doors 16, and are stored within a memory 17 of the elevator control 14 providing reference pictures.

For monitoring the movement of the doors 6, 16 according to an exemplary embodiment of the invention pictures of the moving doors 6, 16 are recorded at the same time intervals as the reference pictures and compared by means of a comparison device 19, which may be part of the elevator control, with said previously stored reference pictures. This comparison may be performed by applying standard methods of image evaluation providing a respective single door movement difference measure representative for the difference between the recorded pictures and the previously stored reference pictures of the moving doors in the course of a single door movement.

Said single door movement difference measure is then compared to at least one predetermined limit, and a warning signal or an alarm signal is issued in case the difference measure exceeds the predetermined limit indicating that the doors 6, 16 did not open and/or close properly.

According to an exemplary embodiment of the invention there are at least two different limits, and a warning signal requesting a maintenance person to inspect the elevator in order to avoid further damage is issued when the first (lower) limit is exceeded, and the operation of the elevator system 1 is stopped and any further movement of the elevator car 8 is prevented in case a second (larger) limit is exceeded, as in this case any further operation of the elevator system is considered as being unsafe.

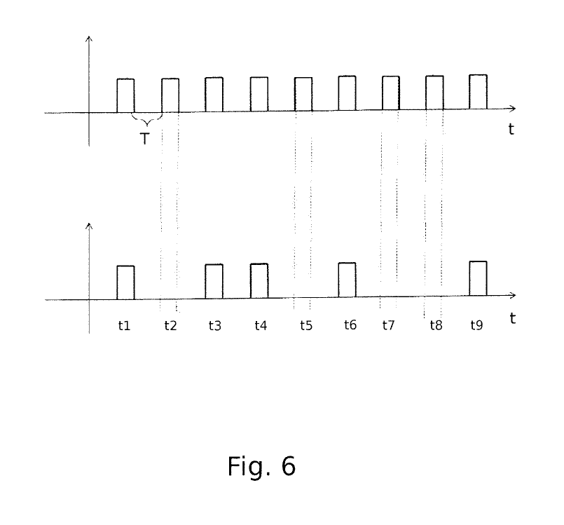

An exemplary method of analysing the recorded pictures, which has been described before, is schematically illustrated in FIG. 6 showing in its upper portion the stored reference pictures, which are symbolized by the rectangles, over a period of time t during a movement of the doors 6, 16 having a constant time lag T.

The actual pictures recorded during the movement of the doors are schematically illustrated in the lower portion of FIGS. 6. At t2, t5, t7 and t8 there is no correspondence between a previously stored reference image and an actually recorded image indicating that the actual movement of the doors 6, 16 deviates from the expected (ideal) movement. Depending on the quantity and quality of the deviation a warning signal or an alarm signal will be issued.

The method may further include determining the position of a respective label 22 within the recorded picture(s) in order to determine the vertical position of the elevator car 8 within the hoistway 2. In case the position exceeds from a predetermined position, the actual position of the elevator car 8 may be adjusted before opening the doors 6, 16 and/or a warning/alarm signal may be issued requesting maintenance of the elevator system 1.

The described procedures may be repeated at each floor 4 approached by the elevator car 8 in order to continuously ensure a safe operation of the elevator car.

A method of monitoring a movement of at least one door, in particular an elevator door, according to an exemplary embodiment of the invention comprises the steps of: (A) recording a plurality of pictures of at least one portion of the at least one door during the movement of said elevator door; (B) comparing the recorded pictures with stored reference pictures in order to determine a difference measure representative of the difference between the stored pictures and the reference pictures; (C) comparing the difference measure with a predetermined limit; and (D) issuing a message if the difference measure exceeds the predetermined limit. The message may be an alarm message or a warning message.

The exemplary embodiment allows to continuously monitor the positions of moving parts of the elevator doors allowing error detection and predictive maintenance reducing the shut-down times of the elevator system as it allows a rapid reaction repairing and/or replacing the affected parts before a blockage occurs. Due to continuously monitoring the status of the elevator, disturbances are detected at an early stage and the performance and position accuracy of the elevator is preserved.

Particular embodiments may include any of the following optional features, alone or in combination:

In an embodiment step (A) includes recording the plurality of pictures for a plurality of door movements; step (B) includes comparing the pictures recorded for each of the door movements with the stored reference pictures in order to determine respective single door movement difference measures; and the method includes determining that the difference measure exceeds the predetermined limit in case a predetermined number of single door movement difference measures exceed a predetermined single door movement limit. This enhances the reliability of the method and helps to avoid false alarms.

In a particular embodiment it is determined that the difference measure exceeds the predetermined limit in case a predetermined number of consecutive single door movement difference measures exceed the predetermined single door movement limit.

In another embodiment step (A) includes recording the plurality of pictures for a plurality of door movements; step (B) includes comparing the pictures recorded for each of the door movements with the stored reference pictures in order to determine respective single door movement difference measures; and the message further includes summing up the respective single door movement difference measures; and determining that the difference measure exceeds the predetermined limit in case the sum of difference measures exceeds the predetermined limit. This embodiment also enhances the reliability of the method and helps to avoid false alarms.

The method in particular may comprise the step of resetting the sum of difference measures after a predetermined number of movements in order to avoid an alarm message to be issued after a temporary disturbance has occurred and vanished.

In an embodiment the recorded pictures may comprise the picture of at least one characteristic portion of the at least one moving door, wherein the characteristic portion in particular includes at least one of a door lock, a gate switch and a door vane. Pictures of at least one characteristic portion of the at least one moving door allow a particular significant monitoring of the door movement. A door lock, a gate switch and a door vane respectively provide significant portions of the door and which are characteristic for its movement.

In an embodiment the method may include to record a plurality of pictures of the at least one moving door at predetermined time intervals. The intervals may be constant. The time intervals may be chosen depending on the speed of the door movement. Pictures recorded at predetermined time intervals, in particular at constant time intervals or at time intervals chosen depending on speed of door movement, provide a representative representation of the door movement allowing reliable error detection.

In an embodiment of the invention there are at least two different limits, and a warning signal requesting a maintenance person to inspect the elevator in order to avoid further damage is issued when the first (lower) limit is exceeded, and the operation of the elevator system is stopped and any further movement of the elevator car is prevented in case a second (larger) limit is exceeded, as in this case any further operation of the elevator system is considered as being unsafe.

In an embodiment the moving door may be an elevator door and the method may include determining the vertical position of the elevator car within a hoistway by recording a picture of a label provided within the hoistway in order to check the vertical position of the elevator car within the hoistway.

At least one marker, in particular a marker including a barcode, may be attached to a wall of the hoistway, the marker comprising information which is representative of its vertical position allowing determining the vertical position of the elevator car within the hoistway by recoding and evaluating a picture of the marker.

According to an exemplary embodiment of the invention, a monitoring device for monitoring a movement of at least one door, in particular an elevator door, comprises: (a) at least one picture recording device or vision sensor configured for recording a plurality of pictures of at least one portion of the at least one door during a movement of the at least one door; (b) a storing device configured for storing a plurality of reference pictures; and (c) a comparison device. The comparison device is configured for comparing at least one of the recorded pictures with at least one of the reference pictures stored within the storage device for determining a difference measure which is representative of the difference between the at least one stored picture and the at least one reference picture; and for issuing a message in case the difference measure exceeds a predetermined limit.

Particular embodiments may include any of the following optional features, alone or in combination:

In an embodiment the monitoring device may comprise at least one illuminating device, which is configured for illuminating at least a portion of the at least one door in order to allow to reliably record pictures of at least one portion of the at least one door independently of ambient light present the environment of the door; in particular in a dark elevator hoistway.

In an embodiment the monitoring device may comprise configured for displaying the recorded pictures and/or the reference pictures facilitating the detection of errors in the door movement. Exemplary embodiments of the invention further include an elevator system comprising a hoistway extending in a basically vertical direction; at least one elevator car configured for moving along the length of the hoistway; at least one moveable door; and a monitoring device according to an exemplary embodiment of the invention for monitoring a movement of said at least one door. The monitoring device may be configured for monitoring the movement of the door of an elevator car. Alternatively or additionally, the elevator system comprises at least one hoistway door and the monitoring device is configured for monitoring the movement of said hoistway door.

Particular embodiments may include any of the following optional features, alone or in combination:

In an embodiment the at least one picture recording device is mounted to at least one elevator car, in particular to the top and/or to the front side of the elevator car allowing an unobstructed view onto the moving parts of the door. Alternatively or additionally at least one picture recording device may be mounted to the hoistway.

### LIST OF REFERENCE NUMERALS

1 elevator system
2 hoistway
4 floor
6 hoistway door
8 elevator car
10 tension member
12 elevator drive
14 elevator control
16 car door
16a car door panel
17 storing device
18 picture recording device
19 comparison device
20 receiver
21 transmitter
22 label
24 door drive mechanism
26 car door lock
26a, 26b car door lock shoes
28 hoistway door lock
28a, 28b hoistway door lock shoes
30 door vanes
32 illuminating device
34 display

1. A method of monitoring a movement of at least one door (6, 16), in particular an elevator door (6, 16), comprising the steps of:
(A) recording a plurality of pictures of at least one portion of the at least one door (6, 16) during the movement of said door (6, 16);
(B) comparing the recorded pictures with stored reference pictures in order to determine a difference measure representative of the difference between the stored pictures and the reference pictures;
(C) comparing the difference measure with a predetermined limit; and
(D) issuing a message if the difference measure exceeds the predetermined limit.

2. The method of claim 1, wherein:
step (A) includes recording the plurality of pictures for a plurality of door movements;
step (B) includes comparing the pictures recorded for each of the door movements with the stored reference pictures in order to determine respective single door movement difference measures; and the method further includes
determining that the difference measure exceeds the predetermined limit in case a predetermined number of single door movement difference measures exceed a predetermined single door movement limit.

3. The method of claim 2, wherein it is determined that the difference measure exceeds the predetermined limit in case a predetermined number of consecutive single door movement difference measures exceed the predetermined single door movement limit.

4. The method of claim 1, wherein the method comprises:
step (A) includes recording the plurality of pictures for a plurality of door movements;
step (B) includes comparing the pictures recorded for each of the door movements with the stored reference pictures in order to determine respective single door movement difference measures;
and the message further includes
summing up the respective single door movement difference measures; and
determining that the difference measure exceeds the predetermined limit in case the sum of difference measures exceeds the predetermined limit, wherein the method in particular comprises to reset the sum of the difference measures after a predetermined number of door movements.

5. The method of claim 1, wherein the recorded pictures comprise the picture of at least one characteristic portion of the at least one moving door (6, 16), wherein the characteristic portion in particular includes at least one of a door lock, a gate switch and a door vane.

6. The method of claim 1, wherein the method includes to record a plurality of pictures of the at least one moving door (6, 16) at predetermined time intervals (T), wherein the intervals are in particular constant.

7. The method of claim 1, further including to issue a warning signal when a first limit is exceeded and to issue an alarm signal and/or to stop the operation of the at least one door (6, 16) when a second limit is exceeded, the second limit in particular being larger than the first limit.

8. A monitoring device for monitoring a movement of at least one door (6, 16), in particular an elevator door (6, 16), comprising:
(a) at least one picture recording device (18) configured for recording a plurality of pictures of at least one portion of the at least one door (6, 16) during a movement of the at least one door (6, 16);
(b) at least one storing device (17) configured for storing a plurality of reference pictures;
(c) a comparison device (19) configured
(c1) for comparing at least one of the recorded pictures with at least one of the reference pictures to determine a difference measure representative of the difference between the at least one stored picture and the at least one reference picture; and
(c2) for issuing an alarm message when the difference measure exceeds a predetermined limit.

9. The monitoring device of claim 8, further comprising at least one illuminating device (32) configured for illuminating at least a portion of the at least one door (6, 16).

10. The monitoring device of claim 8, further comprising at least one display con-figured for displaying the recorded pictures and/or the reference pictures.

11. An elevator system (1), comprising:
a hoistway (2);
at least one elevator car (8) configured for moving along the hoistway (2); at least one moveable door (6, 16); and
at least one monitoring device according to claim 8.

12. The elevator system of claim 11, wherein at least one picture recording device (18) is mounted to the at least one elevator car (8), in particular to the top and/or to the front side of the elevator car (8).

13. The elevator system of claim 12, further comprising at least one marker (22) attached to the hoistway (2), wherein the marker (22) is configured to allow determining the position of the elevator car (8) within the hoistway (2) when recorded by the picture recording device (18).

14. The elevator system of claim 11, wherein at least one picture recording device (18) is mounted to the hoistway (2).

15. The elevator system of claim 11, wherein the elevator car (8) comprises at least one elevator car door (16) and the monitoring device is configured for monitoring movement of said elevator car door (16) and/or wherein the elevator system comprises at least one hoistway door (6) and the monitoring device is configured for monitoring movement of said hoistway door (6).
